(19) United States
(12) Patent Application Publication
(10) Pub. No.: US 2013/0208277 A1
(43) Pub. Date: Aug. 15, 2013

(54) LASER SCAN DEVICE

(71) Applicant: Taeg Gyum KIM, Gyunggi-do (KR)

(72) Inventor: Taeg Gyum KIM, Gyunggi-do (KR)

(73) Assignee: SAMSUNG ELECTRO-MECHANICS CO., LTD., Gyunggi-do (KR)

(21) Appl. No.: 13/536,865

(22) Filed: Jun. 28, 2012

(30) Foreign Application Priority Data
Feb. 15, 2012 (KR) 10-2012-0015455

(51) Int. Cl. G01N 21/47; G01J 1/58

(52) U.S. Cl. 356/338; 250/458.1; 250/235

(57) ABSTRACT

Disclosed herein is a laser scan device. The laser scan device according to a preferred embodiment of the present invention includes a laser light emitting unit emitting a laser beam; a scan unit irradiating the laser beam to a measurement portion of a measurement object; and a condensing unit including a spherical light collector condensing light generated by irradiating the laser beam to the measurement object.

### CROSS REFERENCE TO RELATED APPLICATION

This application claims the benefit of Korean Patent Application No. 10-2012-0015455, filed on Feb. 15, 2012, entitled “Laser Scan Device,” which is hereby incorporated by reference in its entirety into this application.

### BACKGROUND OF THE INVENTION

1. Technical Field

The present invention relates to a laser scan device.

2. Description of the Related Art

A generally used laser scan device is a device that uses laser scan and fluorescent measurement to measurement objects as disclosed in Korean Patent Laid-Open Publication No. 2001-0081616. The laser scan device has been used for a cell biological field, a semiconductor chip test field, a field of testing defects of an exposure circuit pattern and a via hole on a substrate, and the like.

However, the laser scan device has intensity of fluorescence much weaker than intensity of laser beam exciting a sample and may be very restrictedly used according to fluorescent efficiency of a material.

Therefore, in order to overcome the above problems and measure high-quality image, the laser scan device requires a long measuring time.

However, in order to measure a sample having a wide area, a high-speed laser scan is required. In this case, the measuring time may be shortened and signal to noise ratio (SNR) may be degraded.

### PRIOR ART DOCUMENT

### Patent Document

(Patent Document 1) Korean Patent Laid-Open Publication 2001-0081616

### SUMMARY OF THE INVENTION

The present invention has been made in an effort to provide a laser scan device capable of reducing a loss of fluorescence or scattered light as maximally as possible.

In addition, the present invention has been made in an effort to provide a laser scan device capable of increasing image uniformity.

According to a preferred embodiment of the present invention, there is provided a laser scan device, including: a laser light emitting unit emitting a laser beam; a scan unit irradiating the laser beam to a measurement portion of a measurement object; and a condensing unit including a spherical light collector condensing scattered light generated by reflecting the laser beam irradiated through the scan unit from the measurement object and an optical sensor sensing the condensed scattered light.

The condensing unit may be disposed in a direction in which the laser beam is reflected by the measurement object.

The condensing unit may further include a condensing lens condensing the scattered light to the spherical light collector.

The spherical light collector may further include a blocking slit that is disposed at the inlet side of the spherical light collector to transmit the scattered light through the inlet side at the time of the introduction of the scattered light and block the scattered light through the inlet side at the time of emitting the scattered light.

The spherical light collector may have an inlet hole formed at one side thereof and an outlet hole formed at the other side thereof to reflect the scattered light introduced into the inlet hole to an inner side thereof and emit the light through the outlet hole.

The spherical light collector may further include a cylindrical emitting part formed at the outlet side and the optical sensor may be coupled with the emitting part.

The scan unit may include: an optical unit transmitting the laser beam; a reflection mirror reflecting the laser beam transmitting the optical unit to the measurement object; and a scan lens transmitting the laser beam reflected from the reflection mirror so as to be irradiated to the measurement portion of the measurement object.

According to another preferred embodiment of the present invention, there is provided a laser scan device, including: a laser light emitting unit emitting a laser beam; a scan unit irradiating the laser beam to a measurement portion of a measurement object; and a condensing unit condensing the laser beam irradiated and reflected to and from the measurement object, wherein the scan unit includes a dichroic mirror that reflects the laser beam and transmits fluorescence generated from the measurement object to the condensing unit.

The condensing unit may be disposed at an optical axis at which the laser beam is irradiated to the measurement object through the dichroic mirror and may be disposed at a rear of the dichroic mirror.

The condensing unit may include: a spherical light collector; and an optical sensor disposed at an outlet side of the spherical light collector.

The condensing unit may further include a condensing lens that is disposed between the dichroic mirror and the spherical light collector to condense the fluorescence.

The spherical light collector may further include a blocking slit that is disposed at an inlet side of the spherical light collector and transmits the fluorescence at the time of introducing the fluorescence through the inlet side and blocks the fluorescence at the time of emitting the fluorescence.

The spherical light collector may further include a cylindrical emitting part formed at the outlet side thereof.

The scan unit may include: an optical unit transmitting the laser beam; and a scan lens transmitting the laser beam transmitting the optical unit and reflected from the dichroic mirror so as to be irradiated to the measurement portion of the measurement object.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a laser scan device according to a preferred embodiment of the present invention;

FIG. 2 is an exploded perspective view showing a condensing unit in a laser scan device according to the preferred embodiment of the present invention;

FIG. 3 is a cross-sectional view showing the condensing unit in the laser scan device according to the preferred embodiment of the present invention; and

FIG. 4 is a configuration diagram showing a laser scan device according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

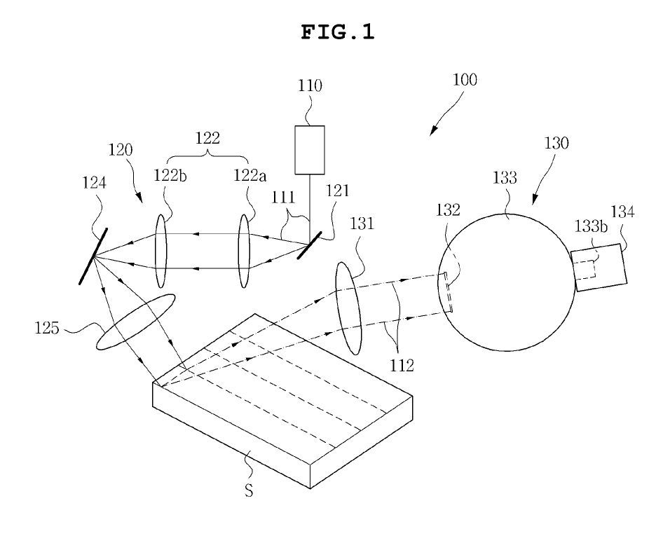

FIG. 1 is a configuration diagram showing a laser scan device according to a preferred embodiment of the present invention.

Referring to FIG. 1, a laser scan device 100 according to a preferred embodiment of the present invention includes a laser light emitting unit 110, a scan unit 120, and a condensing unit 130.

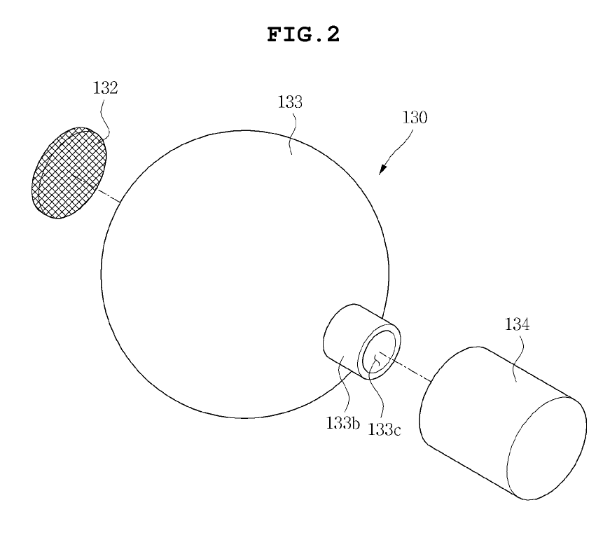

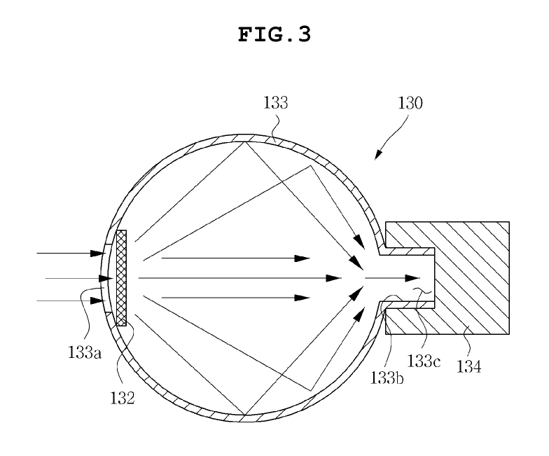

FIG. 2 is an exploded perspective view showing a condensing unit in a laser scan device according to the preferred embodiment of the present invention and FIG. 3 is a cross-sectional view showing the condensing unit in the laser scan device according to the preferred embodiment of the present invention.

Hereinafter, a laser scan device according to a preferred embodiment of the present invention will be described with reference to FIGS. 1 to 3.

Referring first to FIG. 1, a laser light emitting unit 110 emits a laser beam 111.

Referring to FIG. 1, the scan unit 120 irradiates the laser beam 111 emitted from the laser light emitting unit 110 to a measurement portion of a measurement object S.

In addition, the scan unit 120 includes an optical unit 122, a reflection mirror 124, and a scan lens 125, wherein the optical unit 122 includes a first lens 122a and a second lens 122b.

In this configuration, the first lens 122a and the second lens 122b are sequentially disposed from the laser light emitting unit 110 side to transmit the laser beam 111 reflected from the scan mirror 121 to the reflection mirror 124. In this case, the first lens 122a may transmit the laser beam 111 to the second lens 122b so as to be converged and the second lens 122b may be condensed to the laser beam 111 to the reflection mirror 124. However, the optical unit 122 according to the preferred embodiment of the present invention does not necessarily include the first lens 122a and the second lens 122b.

Further, the reflection mirror 124 reflects the laser beam 111 transmitting the optical unit 122 toward the measurement object S.

In this case, the reflection mirror 124 can control a reflection angle of the laser beam 111.

In addition, the scan lens 125 transmits the laser beam 111 reflected through the reflection mirror 124 so as to be irradiated to the measurement portion of the measurement object S.

Meanwhile, the scan unit 120 according to the preferred embodiment of the present invention may further include the scan mirror 121. In this configuration, the scan mirror 121 transmits the laser beam 111 emitted from the laser light emitting unit 110 to the first lens 122a of the optical unit 122. In this case, the scan mirror 121 may include a reflecting body to reflect the laser beam 111 to the first lens 122a and control the reflection angle.

In addition, the laser scan device 100 according to the preferred embodiment of the present invention can move a portion to which the laser beam 111 of the measurement object is irradiated through the scan unit 120 and scan the measurement object S with laser. For example, the portion to which the laser beam 111 of the measurement object S is irradiated may move by controlling the reflection angle of the reflection mirror 124 or the scan mirror 121.

Referring to FIGS. 1 to 3, the condensing unit 130 condenses and senses a scattered light 112 that is generated due to the laser beam 111 irradiated to the measurement object S. In this case, the scattered light 112 may be the reflection light that is generated by the laser beam 111 reflected from the measurement object S.

In this case, the condensing unit 130 may include a spherical light collector 133 and an optical sensor 134 and may further include a condensing lens 131.

In addition, the condensing unit 130 is disposed in a propagation direction of the laser beam 111 and may be disposed in a direction in which the laser beam 111 is irradiated and reflected to and from the measurement object S.

However, the condensing unit 130 of the laser scan device 100 according to the preferred embodiment of the present invention is not necessarily disposed only in a direction in which the laser beam 111 is reflected to the measurement object S to sense only the scattered light 112. For example, the condensing unit 130 is disposed at a top of the measurement object S to measure the scattered light 112 and the fluorescence. In this case, the fluorescence may be light that is generated from the laser beam 111 irradiated and reflected to and from the measurement object S.

First, the spherical light collector 133 is formed of a spherical shape having a space formed therein. In addition, in the spherical light collector 133, an inlet side into which the scattered light is introduced is provided with an inlet hole 133a and an outlet side from which the scattered light 112 introduced from the inlet side is emitted is provided with an outlet hole 133c. Moreover, an inner side of the spherical light collector 133 is provided with a spherical reflection surface, such that the scattered light 112 introduced from the inlet side is reflected through the reflection surface and is emitted to the outlet side.

Further, the inlet hole 133a of the inlet side of the spherical light collector 133 is provided with a blocking slit 132 to transmit the scattered light 112 to a blocking slit 132 through the inlet hole 133a of the inlet side at the time of the introduction of the scattered light 112 and blocks the scattered light 112 emitted through the inlet hole 133a of the inlet side. As a result, the blocking slit 132 introduces the scattered light 112 to the inlet side of the spherical light collector 133, but can prevent the scattered light 112 from being emitted to the inlet side.

In this case, the laser scan device 100 according to the preferred embodiment of the present invention is not limited to the case the scattered light is introduced only through the inlet hole 133a of the spherical light collector 133 when the scattered light 112 is introduced into the spherical light collector 133. For example, the inlet side of the spherical light collector 133 is provided with a transmitting unit (not shown) through which the scattered light 112 may be transmitted, such that the scattered light 112 may be introduced through the transmitting unit.

In addition, the outlet side of the spherical light collector 133 is provided with the optical sensor 134 to sense the scattered light 112 introduced into the outlet side.

In addition, the spherical light collector 133 may further include a cylindrical emitting part 133b disposed at the outlet side of the cylindrical light collector. In this case, the inner side of the emitting part 133b is provided with an outlet hole 133c that provides a path through which the scattered light 112 is emitted, such that the scattered light 112 may be better introduced into the optical sensor 134. In this case, the optical sensor 134 is mounted at the emitting part 133b to sense the scattered light 112 introduced to the optical sensor 134 through the emitting part 133b.

Further, the condensing lens 131 is disposed between the measurement object S and the spherical light collector 133 to condense the scattered light 112 reflected from the measurement object S to the spherical light collector 133. As a result, the scattered light 112 is condensed by the condensing lens 131 and the spherical light collector 133 and as a result, the loss of the scattered light 112 can be reduced.

The laser scan device 100 according to the preferred embodiment of the present invention configured as described above has good condensing efficiency using the spherical light collector 133 and can increase image uniformity according to the scan position of the measurement object S.

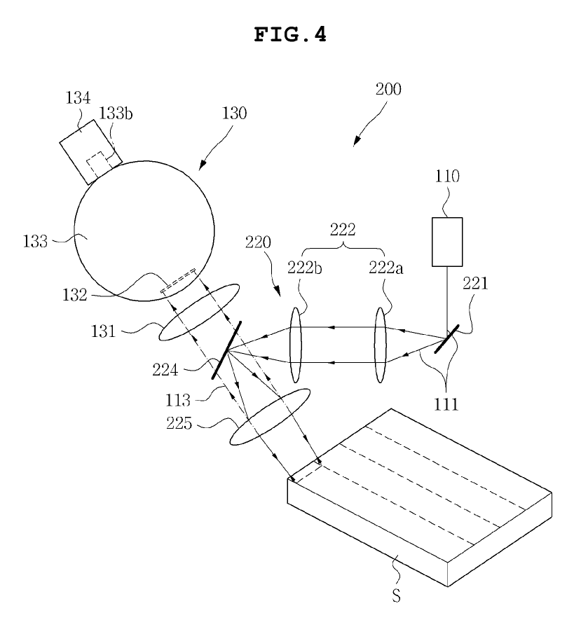

FIG. 4 is a configuration diagram showing the laser scan device according to another preferred embodiment of the present invention.

Referring to FIG. 4, the laser scan device 200 according to another preferred embodiment of the present invention includes the light emitting unit 110, a scan unit 220, the condensing unit 130, and a dichroic mirror 224.

Hereinafter, the laser scan device 200 according to another preferred embodiment of the present invention will be described in more detail with reference to FIG. 4.

Describing the laser scan device 200 according to another preferred embodiment of the present invention, components similar to the preferred embodiment of the present invention as shown in FIGS. 1 to 3 are denoted by like reference numerals.

First, referring to FIG. 4, the laser light emitting unit 110 emits the laser beam 111.

Referring to FIG. 4, the scan unit 220 irradiates the laser beam 111 emitted from the laser light emitting unit 110 to the measurement portion of the measurement object S.

In addition, the scan unit 220 includes the optical unit 222, the dichroic mirror 224, and the scan lens 225 and the optical unit 222 includes a first lens 222a and a second lens 222b.

In this configuration, the first lens 222a and the second lens 222b are sequentially disposed from the laser light emitting unit 110 side.

The dichroic mirror 224 reflects the laser beam 111 transmitting the optical unit 222 toward the measurement object S and transmits the fluorescence 113 generated by the laser beam 111 irradiated to the measurement object S. In this case, the fluorescence 113 may be transmitted to the spherical light collector 133 that is disposed at the rear of the dichroic mirror 224.

In addition, the scan lens 225 transmits the laser beam 111 reflected through the dichroic mirror 224 so as to be irradiated to the measurement portion of the measurement object S.

Referring to FIG. 4, the condensing unit 130 condenses and senses the fluorescence 113 that is generated due to the laser beam 111 irradiated to the measurement object S. In this case, the condensing unit 130 may include a spherical light collector 133 and an optical sensor 134 and may further include the condensing lens 131.

Further, the condensing unit 130 is disposed at an optical axis at which the laser beam 111 is irradiated to the measurement object S through the dichroic mirror 224. In this case, the measurement object S is disposed at the front of the dichroic mirror 224 the condensing unit 130 is disposed at the rear thereof.

However, the condensing unit 130 of the laser scan device 200 according to another preferred embodiment of the present invention is necessarily disposed on the optical axis of the laser beam 111 and does not sense only the fluorescence 113. For example, the condensing unit 130 may be disposed at the top of the measurement object S to measure the fluorescence 113 and the scattered light 112. In this case, the scattered light 112 may be the reflection light that is generated by, for example, the laser beam 111 reflected from the measurement object S.

Referring to FIGS. 3 and 4, the spherical light collector 133 may be formed in a spherical shape having the space formed therein. Further, the spherical light collector 133 has the inlet sides formed at both sides thereof and having the fluorescence 113 introduced thereinto and an outlet side emitted from which the fluorescence 113 introduced from the inlet side is emitted. Moreover, an inner side of the spherical light collector 133 is provided with a spherical reflection surface, such that the fluorescence 113 introduced from the inlet side is reflected through the reflection surface and is emitted to the outlet side.

Further, the inlet side of the spherical light collector 133 is provided with a blocking slit 132 and blocks the fluorescence 113 transmitting the blocking slit 132 at the time of the introduction of the fluorescence through the inlet side and emitted through the inlet side. As a result, the blocking slit 132 introduces the fluorescence 113 to the inlet side of the spherical light collector 133, but can prevent the fluorescence 113 from being emitted to the inlet side. In this case, the inlet side of the spherical light collector 133 is provided with the inlet hole 133a to transmit the fluorescence 113 to the blocking slit 132 through the inlet hole 133a.

In addition, the outlet side of the spherical light collector 133 is provided with the optical sensor 134 to sense the fluorescence 113 introduced into the outlet side.

In addition, the spherical light collector 133 may further include the cylindrical emitting part 133b that is disposed at the outlet side of the spherical light collector. Here, the emitting part 133b is provided with an outlet hole 133c that provides a path through which the fluorescence 113 is emitted. In this case, the optical sensor 134 is mounted at the emitting part 133b to sense the fluorescence 113 introduced to the optical sensor 134 through the emitting part 133b.

Further, the condensing lens 131 is disposed between the dichroic mirror 224 and the spherical light collector 133 to condense the fluorescence 113 generated by the laser beam 111 irradiated and reflected from the measurement object S to the spherical light collector 133. As a result, the fluorescence 113 is condensed by the condensing lens 131 and the spherical light collector 133 and as a result, the loss of the fluorescence 113 can be reduced.

The laser scan device 200 according to another preferred embodiment of the present invention configured as described above has good condensing efficiency using the spherical light collector 133 and can increase the image uniformity according to the scan position of the object surface to be measured.

In addition, the laser scan device 200 according to the preferred embodiment of the present invention includes the dichroic mirror 224, such that the condensing unit 130 disposed at the rear of the dichroic mirror 224 can easily measure the fluorescence 113.

The preferred embodiments of the present invention can reduce the loss of fluorescence or scattered light as maximally as possible at the time of laser scan to increase condensing efficiency of fluorescence or scattered light.

In addition, the preferred embodiment of the present invention can increase the image uniformity at the time of laser scan, thereby measuring the high-quality image of fluorescent or scattered light.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A laser scan device, comprising:
a laser light emitting unit emitting a laser beam;
a scan unit irradiating the laser beam to a measurement portion of a measurement object; and
a condensing unit including a spherical light collector condensing scattered light generated by reflecting the laser beam irradiated through the scan unit from the measurement object and an optical sensor sensing the condensed scattered light.

2. The laser scan device as set forth in claim 1, wherein the condensing unit is disposed in a direction in which the laser beam is reflected by the measurement object.

3. The laser scan device as set forth in claim 1, wherein the condensing unit further includes a condensing lens condensing the scattered light to the spherical light collector.

4. The laser scan device as set forth in claim 1, wherein the spherical light collector has an inlet hole formed at one side thereof and an outlet hole formed at the other side thereof to reflect the scattered light introduced into the inlet hole to an inner side thereof and emit the light through the outlet hole.

5. The spherical light collector as set forth in claim 1, wherein the spherical light collector further includes a blocking slit that is disposed at the inlet side of the spherical light collector to transmit the scattered light through the inlet side at the time of the introduction of the scattered light and block the scattered light through the inlet side at the time of emitting the scattered light.

6. The laser scan device as set forth in claim 1, wherein the spherical light collector further includes a cylindrical emitting part formed at the outlet side, and
the optical sensor is coupled with the emitting part.

7. The laser scan device as set forth in claim 1, wherein the scan unit includes:
an optical unit transmitting the laser beam;
a reflection mirror reflecting the laser beam transmitting the optical unit to the measurement object; and
a scan lens transmitting the laser beam reflected from the reflection mirror so as to be irradiated to the measurement portion of the measurement object.

8. A laser scan device, comprising:
a laser light emitting unit emitting a laser beam;
a scan unit irradiating the laser beam to a measurement portion of a measurement object; and
a condensing unit condensing the laser beam irradiated and reflected to and from the measurement object,
wherein the scan unit includes a dichroic mirror that reflects the laser beam and transmits the fluorescence generated from the measurement object to the condensing unit.

9. The laser scan device as set forth in claim 8, wherein the condensing unit is disposed at an optical axis at which the laser beam is irradiated to the measurement object through the dichroic mirror and is disposed at a rear of the dichroic mirror.

10. The laser scan device as set forth in claim 8, wherein the condensing unit includes:
a spherical light collector; and
an optical sensor disposed at an outlet side of the spherical light collector.

11. The laser scan device as set forth in claim 9, wherein the condensing unit further includes a condensing lens that is disposed between the dichroic mirror and the spherical light collector to condense the fluorescence.

12. The laser scan device as set forth in claim 10, wherein the spherical light collector further includes a blocking slit that is disposed at an inlet side of the spherical light collector and transmits the fluorescence at the time of introducing the fluorescence through the inlet side and blocks the fluorescence at the time of emitting the fluorescence.

13. The laser scan device as set forth in claim 10, wherein the spherical light collector further includes a cylindrical emitting part formed at the outlet side thereof.

14. The laser scan device as set forth in claim 8, wherein the scan unit includes:
an optical unit transmitting the laser beam; and
a scan lens transmitting the laser beam transmitting the optical unit and reflected from the dichroic mirror so as to be irradiated to the measurement portion of the measurement object.
